(19) United States
(12) Patent Application Publication
(10) Pub. No.: US 2013/0311947 A1
(43) Pub. Date: Nov. 21, 2013

(54) NETWORK IMAGE SHARING WITH SYNCHRONIZED IMAGE DISPLAY AND MANIPULATION

(71) Applicant: EKATA SYSTEMS, INC., Sunyvale, CA (US)

(72) Inventors: Allen Tsai, Mountain View, CA (US); Prem Kumar, Saratoga, CA (US); Arun Venkataraman, Campbell, CA (US)

(73) Assignee: EKATA SYSTEMS, INC., Sunnyvale, CA (US)

(21) Appl. No.: 13/841,785

(22) Filed: Mar. 15, 2013

Related U.S. Application Data
(60) Provisional application No. 61/647,704, filed on May 16, 2012.

(51) Int. Cl. G06F 3/0484

(52) U.S. Cl. CPC G06F 3/04842
USPC 715/815

(57) ABSTRACT

Techniques for enabling synchronized media sharing experiences between nodes in a network are provided. In one embodiment, a method is provided for presenting a synchronized “slideshow” of images across multiple, connected computing devices, and allowing synchronized image manipulations and/or or modifications (e.g., panning, zooming, rotations annotations, etc.) across the connected computing devices with respect to one or more images in the slideshow. In yet another embodiment, a method is provided for locally saving an image during the course of the slideshow on one or more of the connected computing devices.

### CROSS-REFERENCES TO RELATED APPLICATIONS

The present application claims the benefit and priority under 35 U.S.C. 119(e) of U.S. Provisional Application No. 61/647,704, filed May 16, 2012, entitled “NETWORK IMAGE SHARING WITH SYNCHRONIZED IMAGE DISPLAY AND MANIPULATION,” the entire contents of which are incorporated herein by reference for all purposes.

### BACKGROUND

The present disclosure relates generally to content distribution over a network, and more particularly to techniques for enabling the synchronized display and manipulation of images between nodes in a network.

With the popularity of online social networks and media sharing/distribution networks, more and more people are sharing their personal media content (e.g., pictures, videos, etc.) with friends, family, and others. The most popular method for achieving this sharing experience has been through the uploading of content by a user, from platforms such as a PC or a mobile phone through the Wide Area Network (“WAN”), to an online service such as Facebook or YouTube. Once uploaded, other people can gain access to the content through a method determined by the service. Unfortunately, this experience is predominantly “static” in nature; in other words, upon the availability of the content, other users access the content asynchronously, with little or no interaction with the original uploader. Accordingly, it would desirable to have improved techniques for content sharing that provide a more dynamic and interactive user experience.

### SUMMARY

Embodiments of the present invention provide techniques for enabling synchronized, curated media sharing experiences between nodes in a network in a real-time and interactive fashion. In one embodiment, a first computing device can receive, from a user, a selection of one or more images, and can cause the one or more images to be presented synchronously on the first computing device and one or more second computing devices. While a first image in the one or more images is concurrently presented on the displays of the first computing device and the one or more second computing devices, the first computing device can receive, from the user, an input signal corresponding to an image zoom or pan operation to be performed with respect to the first image, and can update the display of the first computing device to reflect the image zoom or pan operation. The first computing device can then transmit, to the one or more second computing devices, a command for updating the displays of the one or more second computing devices to reflect the image zoom or pan operation.

A further understanding of the nature and advantages of the embodiments disclosed herein can be realized by reference to the remaining portions of the specification and the attached drawings.

### BRIEF DESCRIPTION OF THE DRAWINGS

FIGS. 1A and 1B are simplified block diagrams illustrating exemplary system configurations in accordance with embodiments of the present invention.

FIG. 2 is a simplified block diagram of a computing device in accordance with an embodiment of the present invention.

FIGS. 3A and 3B are flow diagrams of processes for enabling a synchronized slideshow in accordance with an embodiment of the present invention.

FIGS. 4A and 4B are flow diagrams of processes for enabling synchronized image manipulation (e.g., zooming, panning, and rotation) during a slideshow in accordance with an embodiment of the present invention.

FIGS. 5A and 5B are flow diagrams of processes for enabling synchronized image annotating (“doodling”) during a slideshow in accordance with an embodiment of the present invention.

FIGS. 6A and 6B are flow diagrams of processes for enabling local image saving during a slideshow in accordance with an embodiment of the present invention.

FIG. 7 is a flow diagram of a process for entering an offline viewing mode during a slideshow in accordance with an embodiment of the present invention.

FIGS. 8-11 are exemplary graphical user interfaces in accordance with an embodiment of the present invention.

### DETAILED DESCRIPTION

In the following description, for purposes of explanation, numerous examples and details are set forth in order to provide an understanding of embodiments of the present invention. It will be evident, however, to one skilled in the art that certain embodiments can be practiced without some of these details, or can be practiced with modifications or equivalents thereof.

Embodiments of the present invention provide techniques for enabling synchronized, curated media sharing experiences between nodes in a network in a real-time and interactive fashion. In one set of embodiments, a first computing device can receive, from a user (i.e., curator), a selection of a group of images resident on the first computing device. The selected group of images can correspond to images that the curator would like to share with other individuals in an interactive, “slideshow” presentation format. The first computing device can further establish connections with one or more second computing devices over a network. In a particular embodiment, the network can be an ad-hoc, wireless peer-to-peer (P2P) network. In other embodiments, the network can by any type of computer network conventionally known in the art. The first computing device can then cause the selected images to be presented in a synchronized manner on the first computing device and the one or more second computing devices.

For example, in one embodiment, the first computing device can cause a first image in the selected group of images to be displayed concurrently on an output device of the first computing device and on output devices of the one or more second computing devices. The first computing device can subsequently receive, from the curator, an input signal (e.g., a “swipe right or left” gesture) to transition from the first image to a second image in the selected group of images. Upon receiving the input signal, the first computing device can display the second image on the output device of the first computing device. At the same time, the first computing device can transmit a command identifying the second image to the one or more second computing devices, thereby causing those computing devices to simultaneously (or near simultaneously) transition to displaying the second image. In this manner, both the curator and the users operating the second computing devices (i.e., viewers) can view the same sequence of images at substantially the same time.

While a particular image is being displayed on the first computing device and the one or more second computing devices, the curator (and/or one of the viewers) can enter, on his/her respective computing device, an input signal for manipulating or otherwise modifying the presented image. Examples of such image manipulation/modification functions include resizing the image (i.e., zooming in or out), panning the image, rotating the image, annotating (i.e., “doodling” on) the image, and the like. In response, the image manipulations or modifications can be displayed on the computing device where the input signal was entered, as well as propagated, in real-time or near real-time, to the other connected computing devices. Thus, the image manipulations/modifications can be concurrently viewed on all of these devices.

Further, while a particular image is being presented on the first computing device and the one or more second computing devices, one of the viewers can enter, on his/her respective computing device, an input signal (e.g., a “swipe down” gesture) for locally saving the presented image on the device. In certain embodiments, this feature can be controlled by a content sharing policy that is defined by the curator. If the content sharing policy allows local saving of the image, the image can be stored in a user-defined local storage location.

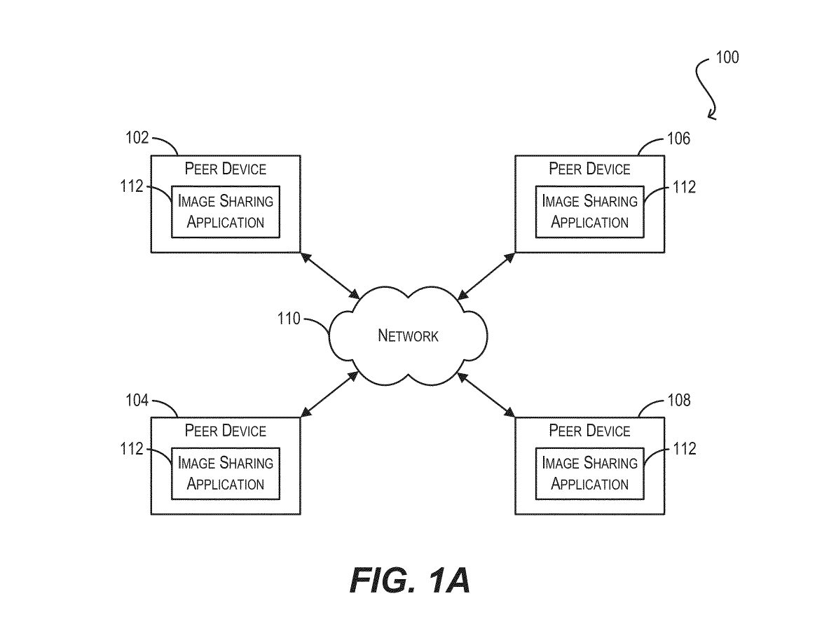

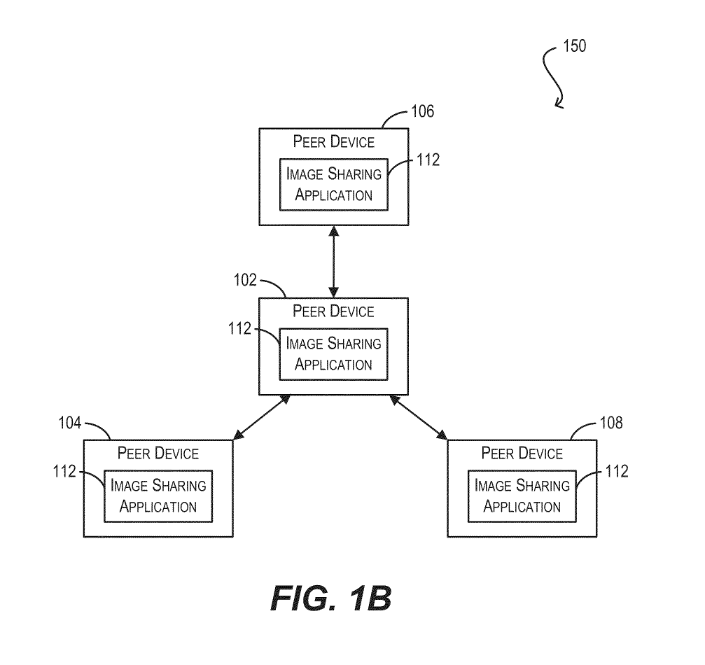

FIG. 1A is a simplified block diagram of a system configuration 100 according to an embodiment of the present invention. As shown, system configuration 100 includes a number of peer devices 102-108 that are communicatively coupled via a network 110. Peer devices 102-108 can each be any type of computing device known in the art, such as a desktop computer, a laptop computer, a mobile phone, a tablet, a video game system, a set-top/cable box, a digital video recorder, and/or the like. Although four peer devices are depicted in FIG. 1, any number of such devices may be supported. In a particular embodiment, system configuration 100 can consist solely of handheld devices (e.g., mobile phones or tablets). In other embodiments, system configuration 100 can consist of a mixture of handheld and larger form factor (e.g., desktop computer) devices.

Network 110 can be any type of data communications network known in the art, such as a local area network (LAN), a wide-area network (WAN), a virtual network (e.g., VPN), or the Internet. In certain embodiments, network 106 can comprise a collection of interconnected networks.

In operation, peer devices 102-108 can communicate to enable various networked image sharing functions in accordance with embodiments of the present invention. For example, as described above, one peer device (e.g., 102) can be operated by an individual (i.e., “curator”) that wishes to share images in a slideshow presentation format with one or more users of the other peer devices (e.g., 104-108). In this case, the curator can invoke an image sharing application 112 on peer device 102 (i.e., the “curator device”) and select, from a collection of images resident on curator device 102, the images he/she wishes to share. The curator can further cause curator device 102 to search for other peer devices (i.e., “viewer devices”) on network 110 that have the same image sharing application 112 installed and wish to connect to curator device 102. Once such viewer devices are found, the curator can select one or more of the viewer devices to join an image sharing session. Curator device 102 can then enter a “slideshow” mode and cause the selected images to be displayed, in synchrony, on curator device 102 and the participating viewer devices.

In one embodiment, the curator operating curator device 102 can control the flow of the image slideshow by providing an input signal on curator device 102 (e.g., a “swipe left or right” gesture) for transitioning to the next or previous image. In response, curator device 102 can send a command to the connected viewer devices to simultaneously (or near simultaneously) transition to the appropriate image. In another embodiment, the curator (or a viewer operating one of the viewer devices) can provide an input signal for modifying or otherwise manipulating a particular image being displayed during the slideshow. This image manipulation/modification can be propagated and displayed in real-time (or near real-time) on all of the connected devices. In yet another embodiment, a viewer operating one of the viewer devices can provide an input signal (e.g., a “swipe down” gesture) for locally saving the original version of a particular image being displayed during the slideshow The specific processing steps that can be performed by devices 102-108 to carry out these functions are described in further detail below.

FIG. 1B is an alternative system configuration 150 according to an embodiment of the present invention. System configuration 150 is substantially similar to configuration 100 of FIG. 1A; however, instead of being connected to a structured network 110, the various peer devices 102-108 of configuration 150 can discover and communicate directly with each other as peers, thereby forming network connections in an ad hoc manner Such peer-to-peer (P2P) ad hoc networks are different from traditional client-server architecture, where communications are usually with, or provisioned by, a local or remote central server. In configuration 150, curator device 102 can act as a “group owner,” thereby allowing other devices 104-108 to see it as such and connect to it. Once this ad hoc network is established, various services (such as the image sharing functions described herein) can be provisioned by curator device 102 to the connected devices 104-108. Such a configuration is useful for efficiently sharing files, media streaming, telephony, real-time data applications, and other communications. In one embodiment, peer devices 102-108 of configuration 150 are connected via a wireless protocol, such as WiFi Direct, Bluetooth, or the like. In other embodiments, peer devices 102-108 can be connected via wired links.

It should be appreciated that systems 100 and 150 are illustrative and not intended to limit embodiments of the present invention. For example, the various components depicted in systems 100 and 150 can have other capabilities or include other subcomponents that are not specifically described. One of ordinary skill in the art will recognize many variations, modifications, and alternatives.

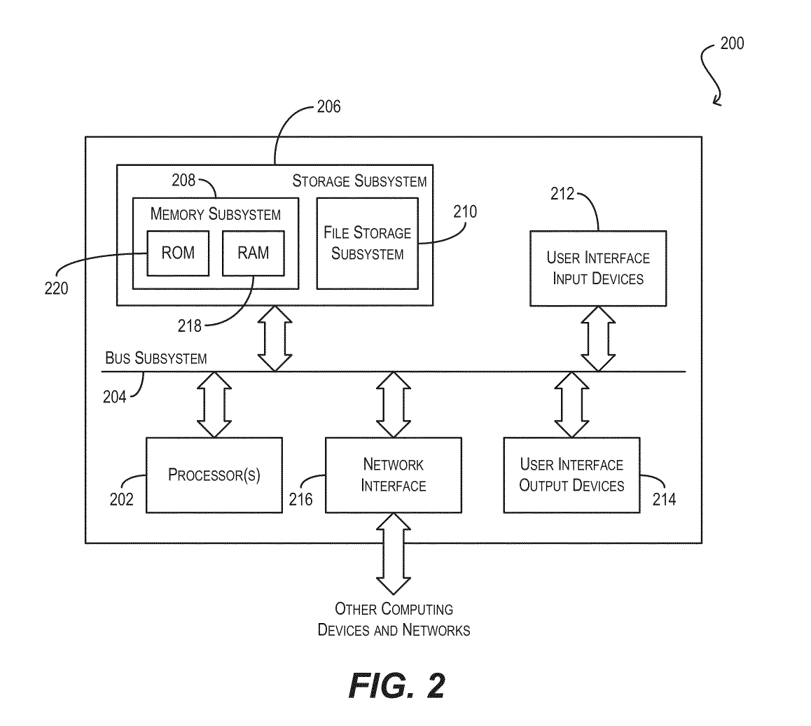

FIG. 2 is a simplified block diagram of a computing device 200 according to an embodiment of the present invention. Computing device 200 can be used to implement any of the peer devices described with respect to system configurations 100 and 150 of FIGS. 1A and 1B. As shown, computing device 200 can include one or more processors 202 that communicate with a number of peripheral devices via a bus subsystem 204. These peripheral devices can include a storage subsystem 206 (comprising a memory subsystem 208 and a file storage subsystem 210), user interface input devices 212, user interface output devices 214, and a network interface subsystem 216.

Bus subsystem 204 can provide a mechanism for letting the various components and subsystems of computing device 200 communicate with each other as intended. Although bus subsystem 204 is shown schematically as a single bus, alternative embodiments of the bus subsystem can utilize multiple busses.

Network interface subsystem 216 can serve as an interface for communicating data between computing device 200 and other computing devices or networks. Embodiments of network interface subsystem 216 can include wired (e.g., coaxial, twisted pair, or fiber optic Ethernet) and/or wireless (e.g., Wi-Fi, cellular, Bluetooth, etc.) interfaces.

User interface input devices 212 can include a keyboard, pointing devices (e.g., mouse, trackball, touchpad, etc.), a scanner, a barcode scanner, a touch-screen incorporated into a display, audio input devices (e.g., voice recognition systems, microphones, etc.), and other types of input devices. In general, use of the term “input device” is intended to include all possible types of devices and mechanisms for inputting information into computing device 200.

User interface output devices 214 can include a display subsystem, a printer, a fax machine, or non-visual displays such as audio output devices, etc. The display subsystem can be a cathode ray tube (CRT), a flat-panel device such as a liquid crystal display (LCD), or a projection device. In general, use of the term “output device” is intended to include all possible types of devices and mechanisms for outputting information from computing device 200.

Storage subsystem 206 can include a memory subsystem 208 and a file/disk storage subsystem 210. Subsystems 208 and 210 represent non-transitory computer-readable storage media that can store program code and/or data that provide the functionality of embodiments of the present invention.

Memory subsystem 208 can include a number of memories including a main random access memory (RAM) 218 for storage of instructions and data during program execution and a read-only memory (ROM) 220 in which fixed instructions are stored. File storage subsystem 210 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computing device 200 is illustrative and not intended to limit embodiments of the present invention. Many other configurations having more or fewer components than device 200 are possible.

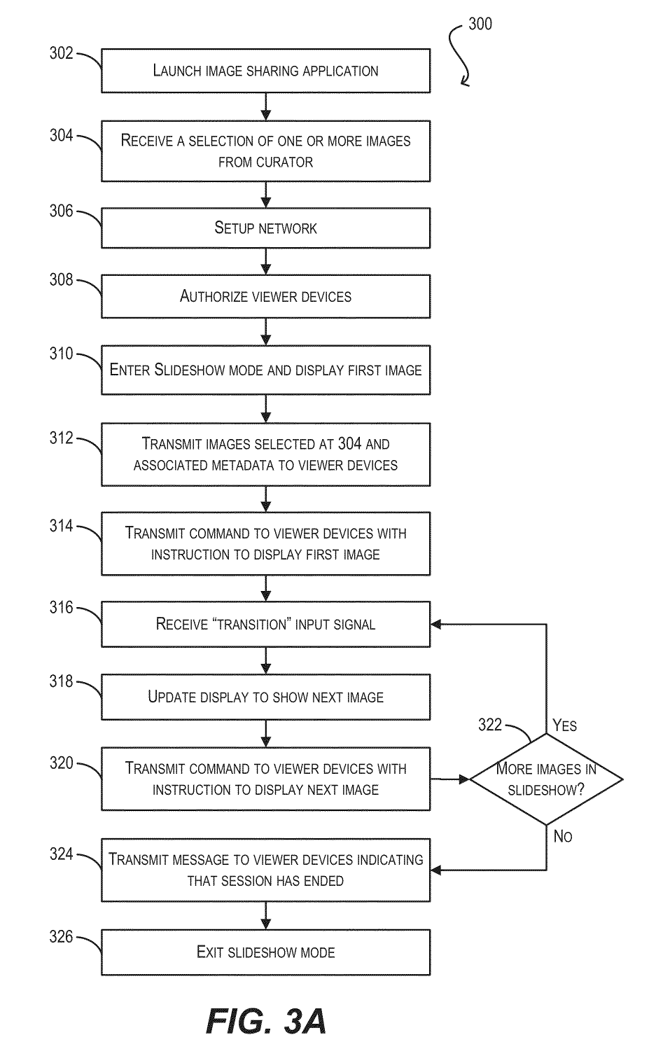

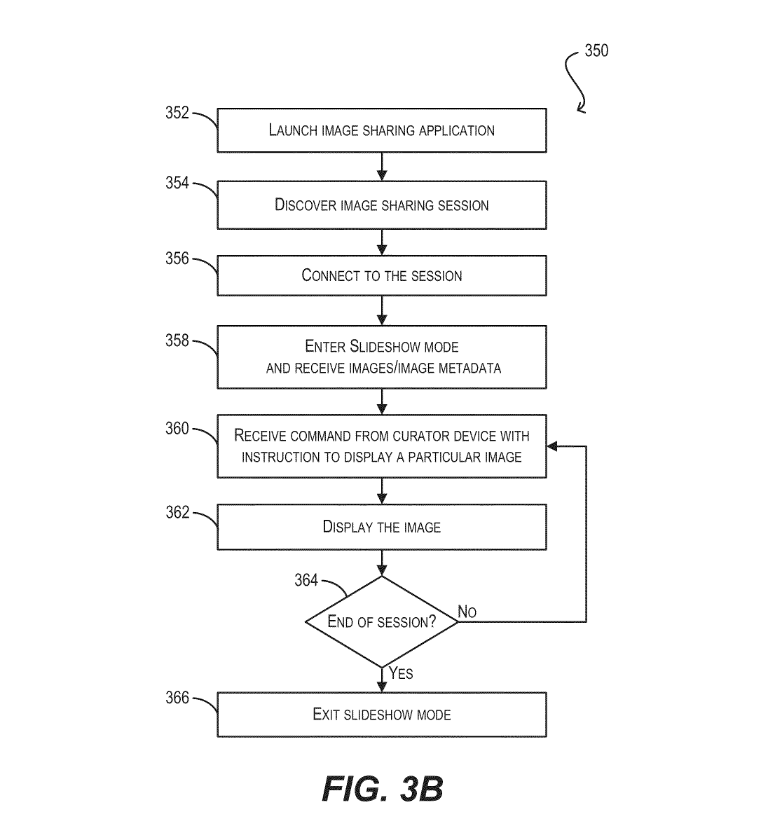

FIG. 3A illustrates a process 300 that can be carried out by curator device 102 of FIGS. 1A and 1B for enabling synchronized slideshow functionality in accordance with an embodiment of the present invention. At block 302, curator device 102 can launch an image sharing application (e.g., application 112 of FIGS. 1A and 1B). At block 304, curator device 102 can receive, from the user (i.e., curator) that is operating device 102, a selection of one or more images resident on device 102. The selected images can represent images that the curator wishes to share in real-time with one or more other users. In one embodiment, the images can correspond to files that are formatted according to a standard image format, such as JPEG, GIF, PNG, etc. In alternative embodiments, the images can correspond to other document file types (or sections thereof), such as pages in a word processing or PDF document, slides in a presentation document, and so on. In the latter case, the curator can simply select the document (e.g., a Word, PDF, or PPT document) to share all of the pages/images within the document.

At block 306, curator device 102 can setup a network for communicating with one or more viewer devices (e.g., devices 104-108 of FIGS. 1A and 1B). For example, as described with respect to configuration 150 of FIG. 1B, curator device 102 can broadcast itself as a “group owner.” In response to this broadcast, one or more viewer devices 104-108 can connect to curator device 102, thereby establishing an ad hoc network between the devices. If the network was previously initialized or is a preexisting network (as in the case of configuration 100 of FIG. 1A), block 306 can be omitted. Curator device 102 can then authorize one or more of the viewer devices 104-108 that have discovered and joined the network for participating in an image sharing session (block 308). The onboarding process of blocks 306 and 308 is referred to as a “join me” model since any viewer device can discover and join the session (subject to the curator's authorization).

In an alternative embodiment (not shown), the onboarding process can follow an “invite” model. In this model, the curator device 102 does not broadcast itself as a group owner. Instead, the curator device 102 sends invitations to one or more other users that have been selected by the curator for participating in the image sharing session. For example, the users may be selected from the curator's contact list, Facebook friends list, etc. Upon receiving the invitations, those users can connect, via their respective viewer devices, to the network/session created by the curator device 102.

Once viewer devices 104-108 have joined in the image sharing session, curator device 102 can enter synchronized slideshow mode and display the first image in the selected group of images on an output device (e.g., touchscreen display) of device 102 (block 310). At substantially the same time as block 310, curator device 102 can transmit all of the images selected at block 304, along with image metadata (e.g., name, date, unique identifier, etc.) to the connected viewer devices (block 312). In addition, curator device 102 can send a command to the connected viewer devices instructing them to display the first image (block 314). In this manner, all of the devices in the session can be synchronized to display the same image.

After some period of time, curator device 102 can receive, from the curator, an input signal (e.g., a “swipe left or right” gesture) to transition to the next (or previous) image in the slideshow (block 316). Alternatively, this image transition signal can be generated automatically by device 102. Upon receiving/generating this signal, curator device 102 can update its display to show the next image (block 318). Further, curator device 102 can send a command identifying the next image to the connected viewer devices, thereby causing those devices to simultaneously (or near simultaneously) transition to displaying the next image (block 320). In this manner, the viewer devices can remain in synch with curator device 102 as the curator and/or device 102 navigates through the slideshow.

Blocks 316-320 can be repeated until the end of the slideshow has been reached (or until the curator terminates the session) (block 322). Curator device 102 can then send a message to the connected viewer devices indicating that the session has ended (block 324) and exit the synchronized slideshow mode (block 326).

It should be appreciated that process 300 is illustrative and that variations and modifications are possible. For example, although block 312 indicates that curator device 102 transmits all of the images in the slideshow to the connected viewer devices at once, in other embodiments the images may be transmitted on an as-needed basis (e.g., immediately prior to display on the viewer devices). In yet other embodiments, the images may be transmitted in batches (e.g., three images at a time, ten images at a time, etc.). This batch size may be configurable based on a number of different factors, such as the total number of images in the slideshow, the available storage space on each viewer device, and so on. One of ordinary skill in the art would recognize many variations, modifications, and alternatives.

FIG. 3B illustrates a corresponding process 350 that can be carried out by a viewer device (e.g., 104-108 of FIGS. 1A and 1B) for enabling synchronized slideshow functionality in accordance with an embodiment of the present invention. Process 350 can be performed by viewer device 104-108 while process 300 is being performed by curator device 102.

At block 352, viewer device 104-108 can launch image sharing application 112 (i.e., the same application running on curator device 102). At block 354, viewer device 104-108 can discover that an image sharing session is being broadcast by curator device 102 in the discovery phase. In response, viewer device 104-108 can connect to the session (block 356). In situations where multiple sessions are being broadcast concurrently by multiple curator devices, the user of viewer device 104-108 can select one session out of the multiple sessions to join.

At block 358, viewer device 104-108 can enter synchronized slideshow mode and can receive image data from curator device 102 corresponding to the data sent at block 312. Further, viewer device 104-108 can receive a command from curator device 102 identifying a particular image to display (corresponding to the command sent at block 314 or 320) (block 360). Viewer device 104-108 can then display the image on an output device (e.g., touchscreen display) of the device (block 362). Blocks 360 and 362 can be repeated until a message is received from curator device 102 indicating that the session has ended (corresponding to the message sent at block 324) (block 364). If the session has ended, viewer device 104-108 can exit the synchronized slideshow mode (block 366).

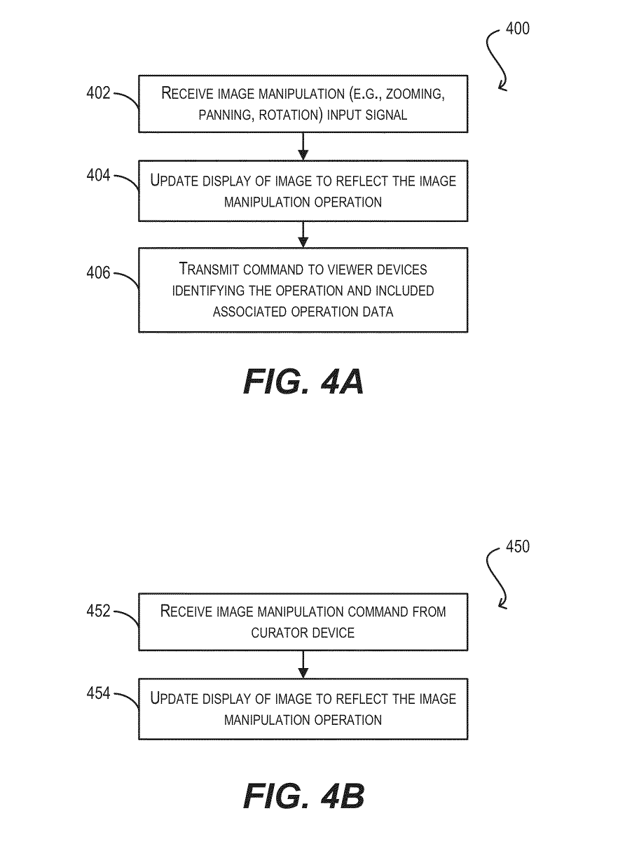

In certain embodiments, during the course of a synchronized slideshow, either the curator or a user operating a connected viewer device can provide, via his/her respective device, one or more input signals for manipulating or modifying a currently displayed image. Examples of such image manipulation and modification functions include image zooming, image panning, image rotation, image annotations or “doodling,” and more. FIG. 4A illustrates a process 400 that can be carried out by curator device 102 of FIGS. 1A and 1B for enabling synchronized image zooming, panning, and rotation in accordance with an embodiment of the present invention. In various embodiments, process 400 assumes that a synchronized slideshow has been initiated and is in progress per FIGS. 3A and 3B.

At block 402, curator device 102 can receive, from the curator, an input signal indicating that the currently displayed image should be zoomed in/out, panned in a particular direction, or rotated. In the case of a zooming operation, the input signal can be a “pinch-to-zoom” gesture that this typically performed on touchscreen devices. In the case of a panning operation, the input signal can be a swiping gesture. In the case of a rotation operation, the input signal can correspond to a physical rotation of curator device 102 (e.g., from landscape to portrait orientation, or vice versa).

At block 404, curator device 102 can update the display of the image to reflect the zooming, panning, or rotation operation. At substantially the same time, curator device 102 can transmit a command to the connected viewer devices identifying the image manipulation operation (e.g., zooming, panning, or rotation), as well as including data needed to replicate the operation (block 406). In certain embodiments, this data can include, e.g., coordinate information and/or vectors corresponding to the input gesture received at block 402.

FIG. 4B illustrates a corresponding process 450 that can be carried out by a viewer device (e.g., 104-108 of FIGS. 1A and 1B) for enabling synchronized image zooming, panning, and rotation in accordance with an embodiment of the present invention. Process 450 can be performed by viewer device 104-108 while process 400 is being performed by curator device 102.

At block 452, viewer device 104-108 can receive an image manipulation command from curator device 102 (corresponding to the command sent at block 406). As noted above, this command can identify an image manipulation operation to be performed with respect to the image currently displayed on viewer device 104-108, as well as data (e.g., coordinates, vectors, etc.) for carrying out the operation. In the case of an image zoom or pan operation, viewer device 104-108 can automatically update the display of the image to reflect the operation (block 454). In the case of an image rotation operation, viewer device 104-108 can provide an indication to the device user (via, e.g., a visible “rotation” symbol, an audible tone, etc.) that he/she should rotate viewer device 104-108 in order to view the image with the same orientation as the curator.

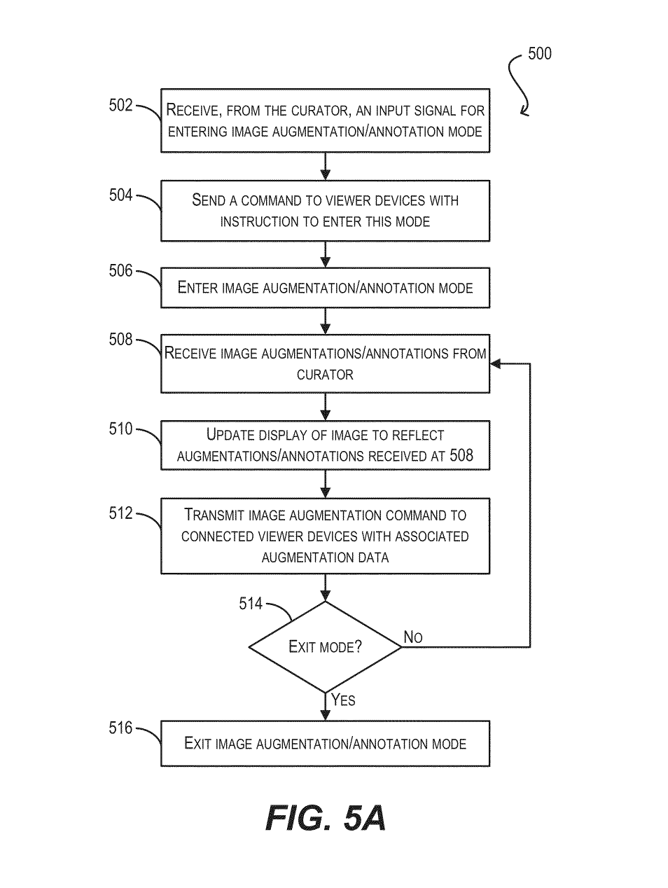

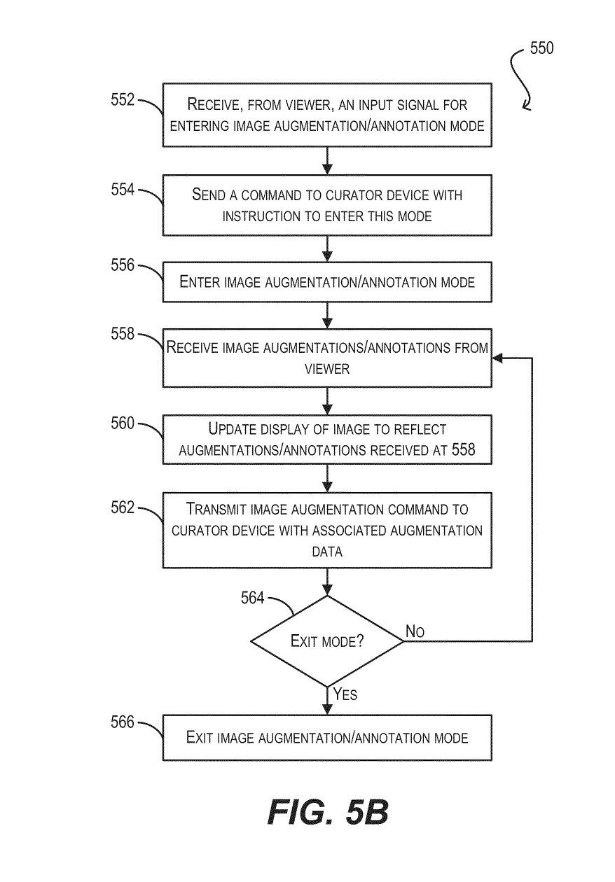

FIG. 5A illustrates a process 500 that can be carried out by curator device 102 of FIGS. 1A and 1B for enabling synchronized image annotating (i.e., “doodling”) in accordance with an embodiment of the present invention. As with process 400 of FIG. 4A, process 500 assumes that a synchronized slideshow has been initiated and is in progress per FIGS. 3A and 3B. In this particular embodiment, the image annotation process is initiated by the curator.

At block 502, curator device 102 can receive, from the curator, an input signal for entering an image augmentation/annotation mode for the currently displayed image. In response, curator device 102 can send a command to the connected viewer devices instructing them to also enter this mode (block 504).

At block 506, curator device 102 can enter the image augmentation/annotation mode. Curator device 102 can then receive, from the curator, one or more annotations or “doodles” to be superimposed on the currently displayed image (block 508). Examples of such annotations or doodles can include mustaches, hats, hairstyles, glasses, eyes, eye-lashes, noses, mouths, lips, ears, scars, texts, text bubbles, and so on. In certain embodiments, the annotations or doodles can be drawn “freehand” by the curator via the touchscreen display of curator device 102. In other embodiments, the curator can select and apply the annotations/doodles from a preconfigured group of symbols/images (e.g., emoticons) or text (e.g., letters or numbers).

At block 510, curator device 102 can update the display of the image to reflect the received annotations/doodles. At substantially the same time, curator device 102 can transmit an image augmentation command to the connected viewer devices that includes data needed to replicate the annotations/doodles (block 512).

Blocks 508-512 can be repeated until the curator either transitions to the next image in the slideshow, or enters an input signal indicating that the image augmentation/annotation mode should be exited (block 514). Curator device 102 can then exit the mode (block 516).

In some cases, the image annotation process can be carried out by a viewer device (e.g., 104-108 of FIGS. 1A and 1B), rather than curator device 102. FIG. 5B illustrates a such a process 550 in accordance with an embodiment of the present invention. In this particular embodiment, the image annotation process is initiated by the user operating the viewer device (i.e., the “viewer”).

At block 552, viewer device 104-108 can receive, from the viewer, an input signal for entering an image augmentation/annotation mode for the currently displayed image. In response, viewer device 104-108 can send a command to curator device 102 indicating its intent to enter this mode (block 554). Upon receiving this command, curator device 102 can forward it to all of the other connected viewer devices.

At block 556, viewer device 104-108 can enter the image augmentation/annotation mode. Viewer device 104-108 can then receive, from the viewer, one or more annotations or “doodles” to be superimposed on the currently displayed image (block 558), in manner that is substantially similar to block 508 of FIG. 5A.

At block 560, viewer device 104-108 can update the display of the image to reflect the received annotations/doodles. At substantially the same time, viewer device 104-108 can transmit an image augmentation command to curator device 102 that includes data needed to replicate the annotations/doodles (block 562). In response, curator device 102 can forward this command and its associated data to the other connected viewer devices so that they can render the annotation/doodle on their respective output devices.

Blocks 558-562 can be repeated until the viewer enters an input signal indicating that the image augmentation/annotation mode should be exited (block 564). Viewer device 104-108 can then exit this mode (block 566).

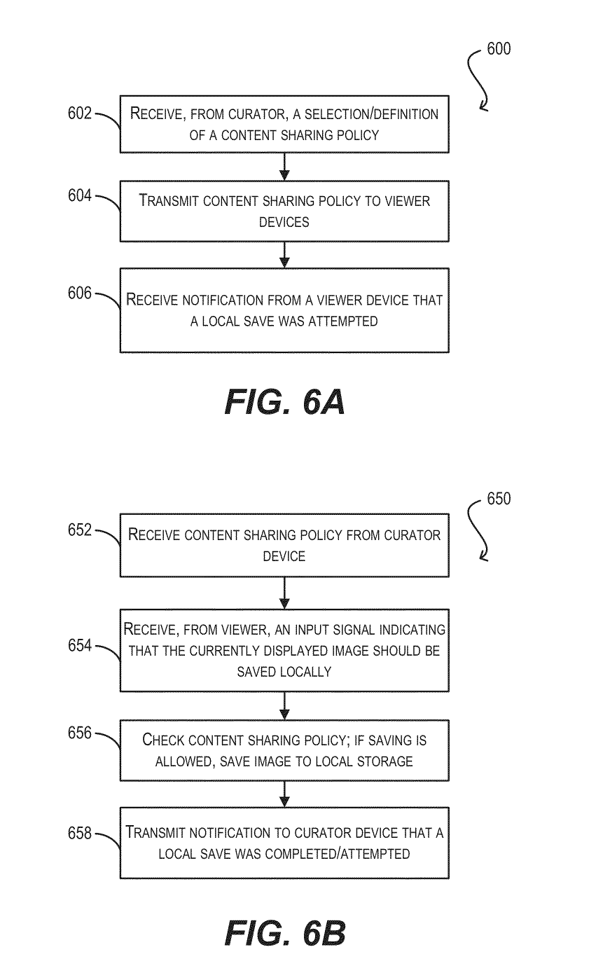

In some cases, during the course of a synchronized slideshow, a viewer operating a connected viewing device (e.g., 104-108) may wish to locally save the currently displayed image. FIG. 6A illustrates a process 600 that can be carried out by curator device 102 for enabling such a local save feature in accordance with an embodiment of the present invention.

At block 602, curator device 102 can receive, from the curator, a selection or definition of a content sharing policy for images to be shared with viewer devices 104-108. The content sharing policy can indicate, e.g., whether the images may be locally saved by a viewer device during the course of a synchronized slideshow. In one embodiment, the content sharing policy can apply different rules to different individual images, such that local saving is enabled or disabled on a per image basis. In alternative embodiments, the content sharing policy can apply a single rule to a group of images.

At block 604, curator device 102 transmit the content sharing policy to viewer devices 104-108. This transmission may occur at the start of the synchronized slideshow. At a later point during the slideshow, curator device 102 can receive a notification indicating that a local save was attempted by one of the viewer devices (block 606).

FIG. 6B illustrates a corresponding process 650 that can be carried out by a viewer device 104-108 for enabling local image saving in accordance with an embodiment of the present invention. Process 650 can be performed by viewer device 104-108 while process 600 is being performed by curator device 102.

At block 652, viewer device 104-108 can receive, from the curator device, the content sharing policy transmitted at block 604 of FIG. 6A.

At block 654, viewer device 104-108 can receive, from the viewer operating the device, an input signal indicating that the currently displayed image should be locally saved. In one embodiment, this input signal can correspond to a “swipe down” gesture on the touchscreen display of the viewer device.

In response, viewer device 104-108 can check the content sharing policy received from curator device 102; if local saving of the current image is allowed, viewer device 104-108 can store the image locally (e.g., on a storage device resident on device 104-108) (block 656). Viewer device 104-108 can then transmit a notification to curator device 102 indicating that local saving of the image was completed/attempted (block 658).

In a further embodiment, while a synchronized slideshow is in progress between curator device 102 and viewer devices 104-108, viewer devices 104-108 can enter an “offline viewing mode.” In this mode, a viewer device can “stay” on a particular image in the slideshow, even if curator device 102 has moved on to the next image. In addition, while in this mode, the viewer using the viewer device can zoom, pan, rotate, or otherwise manipulate the image in any manner, completely independently of curator device 102. Once the viewer wishes to “catch up” with the latest image in the synchronized slideshow, the viewer can activate a “resume” or “catch up” control, which will cause the viewer device to jump to the image that is currently being displayed on curator device 102.

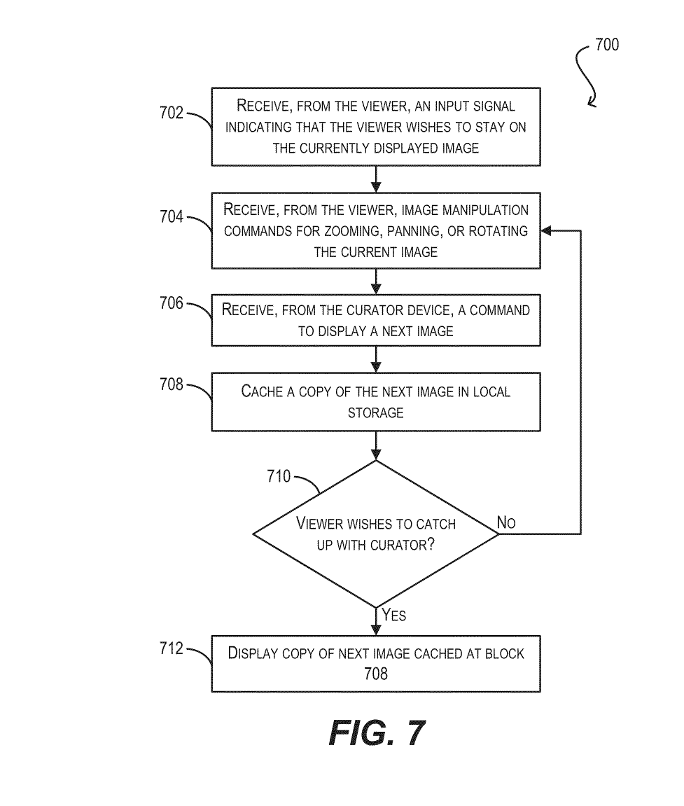

FIG. 7 illustrates a process 700 performed by a viewer device 104-108 that explains the offline viewing mode in greater detail. At block 702, viewing device 104-108 can receive, from the viewer operating the device, an input signal indicating that the viewer wishes to stay on the currently displayed image.

At block 704, the viewer can freely manipulate the current image (e.g., zoom, pan, rotate, etc.), independently of the curator device's status.

At block 706, while the viewer is viewing or manipulating the current image, viewer device 104-108 can receive a command from curator device 102 to display the next image in the slideshow. In a particular embodiment, the receipt of this command can be accompanied by an audible tone that is played by viewer device 104-108 (thereby informing the viewer that the curator has moved on to another image). Upon receiving the command, viewer device 104-108 can cache a copy of the next image in local storage (block 708).

At block 710, viewer device 104-108 may receive an input signal from the viewer indicating that he/she wishes to catch up with the curator. If so, the process can move on to block 712, where viewer device 104-108 can display the copy of the next image that was cached at block 708.

If viewer device 104-108 does not receive any input signal from the viewer at block 710, the process can loop back to block 704. This can continue until the viewer finally decides to catch up with the curator.

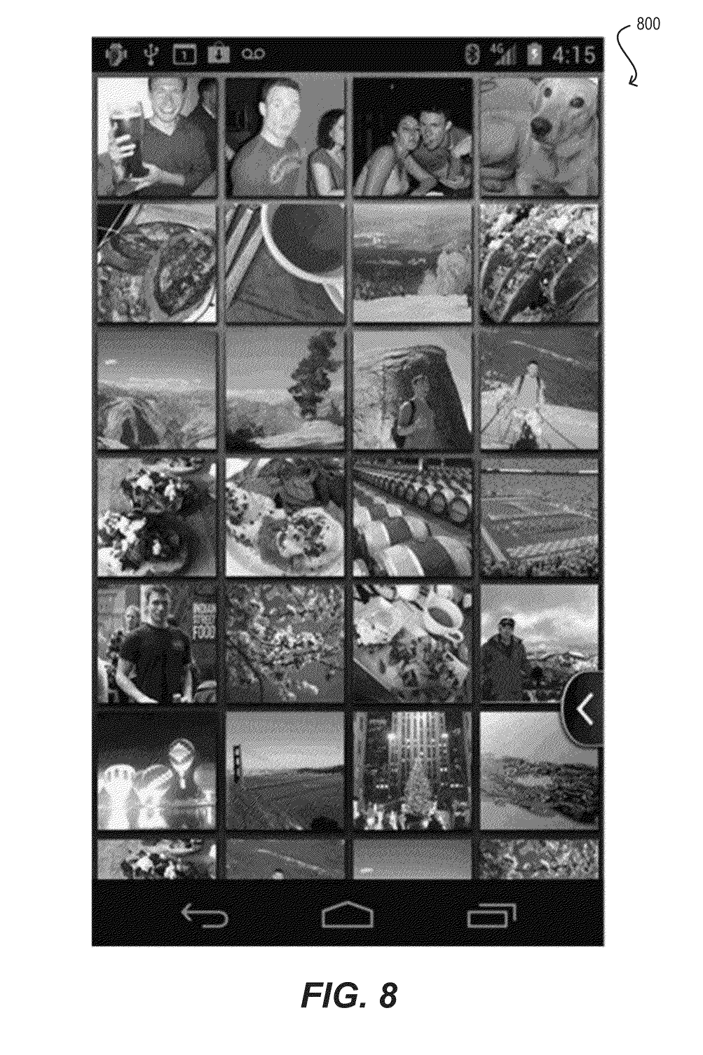

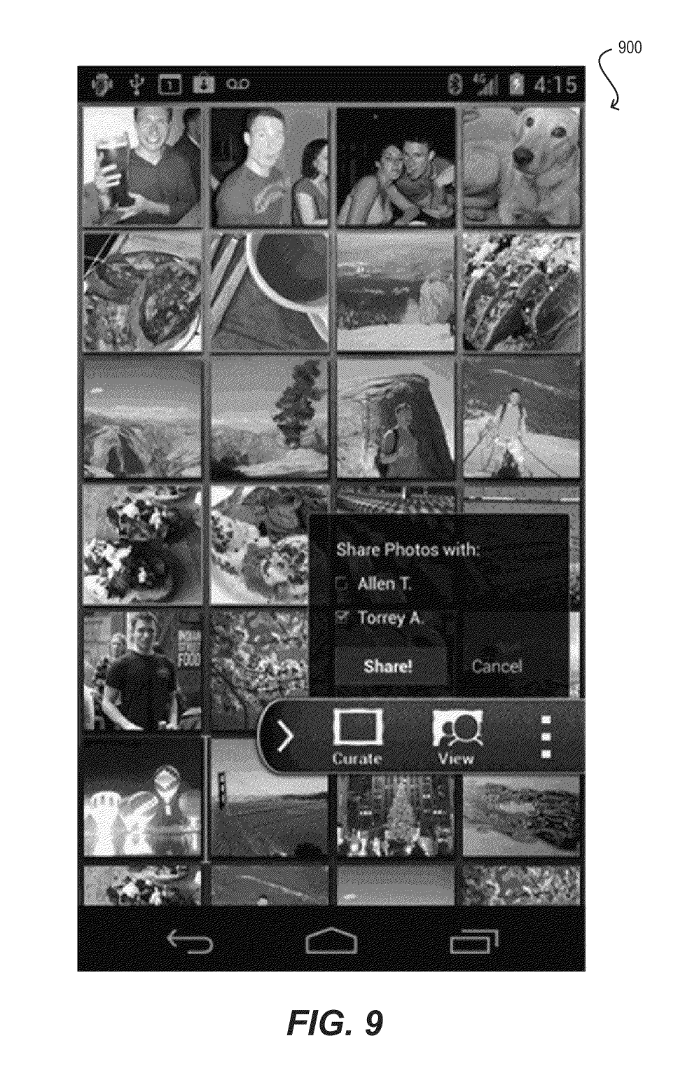

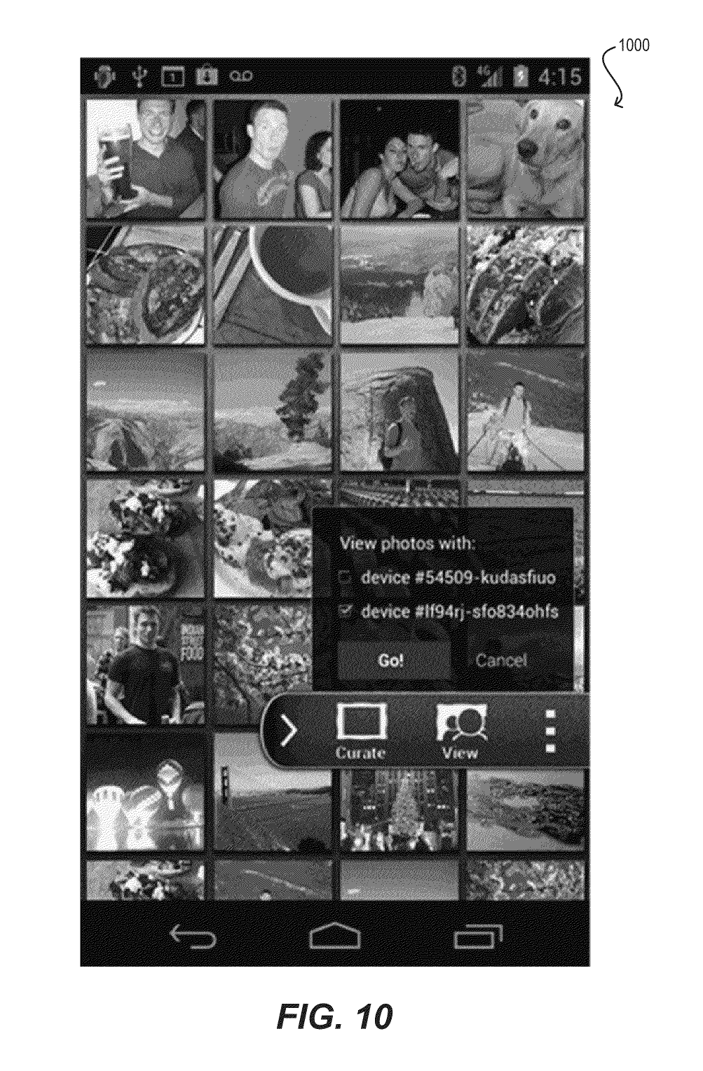

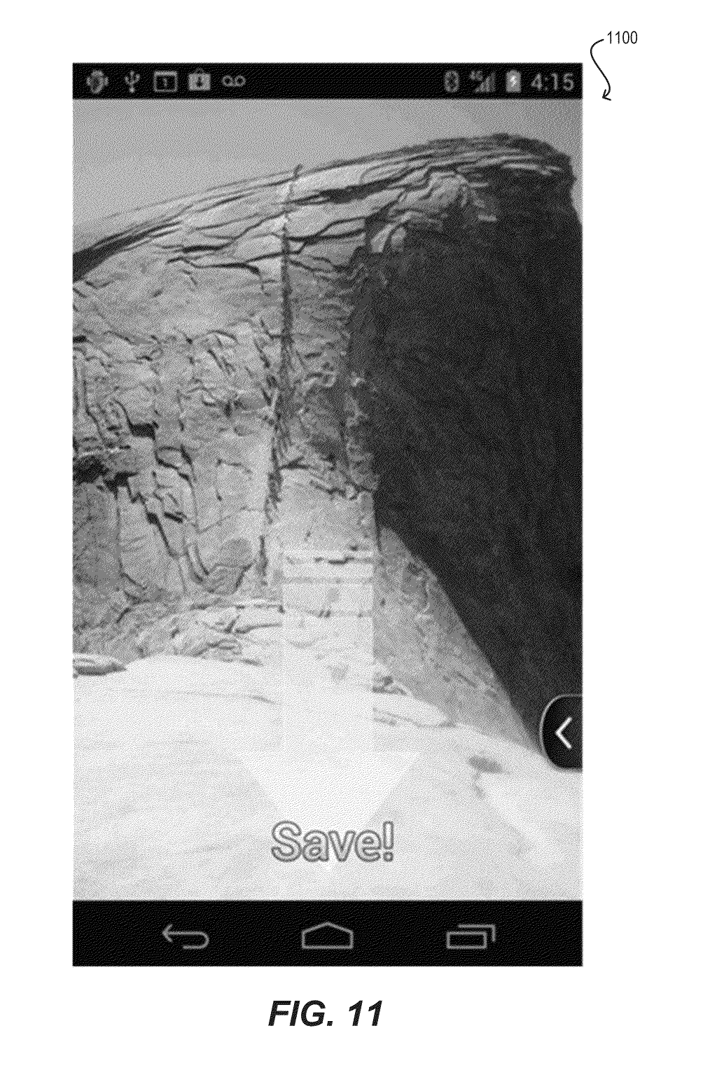

The remaining figures in the present disclosure (FIGS. 8-11) illustrate various graphical user interfaces for implementing some or all of the features described above. For example, FIG. 8 illustrates a graphical user interface 800 that can be displayed on curator device 102 for selecting one or more images to be included in a synchronized slideshow. FIGS. 9 and 10 illustrate graphical user interfaces 900 and 1000 for discovering and selecting one or more viewer devices for a given slideshow session. And FIG. 11 illustrates a graphical user interface 1100 for displaying an image during the course of a synchronized slideshow, as well as using a “swipe down” gesture for locally saving the image at a viewer device.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. For example, although certain embodiments have been described with respect to particular process flows and steps, it should be apparent to those skilled in the art that the scope of the present invention is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the invention as set forth in the following claims.

What is claimed is:

1. A method comprising:
receiving, by a first computing device from a user, a selection of one or more images;
causing, by the first computing device, the one or more images to be presented synchronously on the first computing device and one or more second computing devices, such that when an image in the one or more images is presented on a display of the first computing device, the image is presented concurrently on displays of the one or more second computing devices; and
while a first image in the one or more images is concurrently presented on the displays of the first computing device and the one or more second computing devices:
receiving, by the first computing device from the user, a first input signal corresponding to an image zoom or pan operation to be performed with respect to the first image;
updating the display of the first computing device to reflect the image zoom or pan operation; and
transmitting, to the one or more second computing devices, a command for updating the displays of the one or more second computing devices to reflect the image zoom or pan operation.

2. The method of claim 1 wherein if the first input signal corresponds to an image zoom operation, the first input signal is a pinch-to-zoom gesture that is performed on the display of the first computing device.

3. The method of claim 1 wherein if the first input signal corresponds to an image pan operation, the first input signal is a swiping gesture that is performed on the display of the first computing device.

4. The method of claim 1 further comprising, while the first image is concurrently presented on the displays of the first computing device and the one or more second computing devices:
receiving, by the first computing device from the user, a second input signal corresponding to an image rotation operation to be performed with respect to the first image;
updating the display of the first computing device to reflect the image rotation operation; and
transmitting, to the one or more second computing devices, a command identifying the image rotation operation.

5. The method of claim 4 wherein the second input signal is a physical rotation of the first computing device.

6. The method of claim 4 wherein, upon receiving the command identifying the image rotation operation, each of the one or more second computing devices generates an indicator indicating that the second computing device should be physically rotated.

7. The method of claim 1 further comprising, while the first image is concurrently presented on the displays of the first computing device and the one or more second computing devices:
receiving, by a second computing device in the one or more second computing devices, a second input signal from a user of the second computing device, the second input signal corresponding to a request to locally save the first image on the second computing device;
checking a content sharing policy to determine whether local saving of the first image is allowed; and
if local saving is allowed by the content sharing policy, storing the first image on a local storage component of the second computing device.

8. The method of claim 7 wherein the second input signal is a swipe-down gesture performed on the display of the second computing device.

9. The method of claim 8 wherein the content sharing policy is defined by the user of the first computing device.

10. The method of claim 1 further comprising, while the first image is concurrently presented on the displays of the first computing device and the one or more second computing devices:
receiving, by the first computing device from the user, a second input signal corresponding to an annotation to be added to the first image;
updating the display of the first computing device to present the first image with the annotation;
and, concurrently with the updating, transmitting, to the one or more second computing devices, a command for updating the displays of the one or more second computing devices to reflect the annotation.

11. The method of claim 10 wherein the annotation corresponds to one or more strokes drawn freehand by the user on the display of the first computing device.

12. The method of claim 10 wherein the annotation corresponds a symbol or text element that is selected from a predefined group of symbols or text elements.

13. The method of claim 1 further comprising, while the first image is concurrently presented on the displays of the first computing device and the one or more second computing devices:
receiving, by the first computing device from the user, a second input signal for transitioning from the first image to a second image in the one or more images;
updating the display of the first computing device to present the second image; and
transmitting, to the one or more second computing devices, a command for presenting the second image on the displays of the one or more second computing devices.

14. The method of claim 1 wherein the one or more images correspond to portions of a document.

15. The method of claim 14 wherein the document is a word processing document, a Portable Document Format (PDF) document, or a slide presentation document.

16. The method of claim 1 further comprising, while the first image is concurrently presented on the displays of the first computing device and the one or more second computing devices:
receiving by a second computing device in the one or more second computing devices, a second input signal from a user of the second computing device, the second input signal indicating that the user of the second computing device wishes to stay on the first image;
receiving, by the second computing device, one or more image manipulation commands from the user of the second computing device for zooming, panning, or rotating the first image;
receiving, by the second computing device, a command from the first computing device for displaying a second image, the command including a copy of the second image;
caching, by the second computing device, the copy of the second image in a local storage component;
receiving, by the second computing device, a third input signal from the user of the second computing device, the third input signal indicating that the user of the second computing device wishes to catch up with the user of the first computing device; and
displaying, by the second computing device, the copy of the second image previously cached in the local storage component.

17. The method of claim 1 wherein the first computing device and the one or more second computing devices are connected via an ad hoc, peer-to-peer network.

18. The method of claim 1 wherein the first computing device and the one or more second computing devices are handheld devices.

19. A non-transitory computer readable storage medium having stored thereon program code executable by a processor of a first computing device, the program code comprising:
code that causes the processor to receive, from a user, a selection of one or more images;
code that causes the processor to enable synchronous presentation of the one or more images on the first computing device and one or more second computing devices, such that when an image in the one or more images is presented on a display of the first computing device, the image is presented concurrently on displays of the one or more second computing devices; and
while a first image in the one or more images is concurrently presented on the displays of the first computing device and the one or more second computing devices:
code that causes the processor to receive, from the user, a first input signal corresponding to an image zoom or pan operation to be performed with respect to the first image;
code that causes the processor to update the display of the first computing device to reflect the image zoom or pan operation; and
code that causes the processor to transmit, to the one or more second computing devices, a command for updating the displays of the one or more second computing devices to reflect the image zoom or pan operation.

20. A computing device comprising:
a display;
a processor; and
a memory having stored thereon program code that, when executed by the processor, causes the processor to:
receive, from a user, a selection of one or more images;
enable synchronous presentation of the one or more images on the computing device and one or more other computing devices, such that when an image in the one or more images is presented on the display of the computing device, the image is presented concurrently on displays of the one or more other computing devices; and
while a first image in the one or more images is concurrently presented on the displays of the computing device and the one or more other computing devices:
code that causes the processor to receive, from the user, a first input signal corresponding to an image zoom or pan operation to be performed with respect to the first image;
code that causes the processor to update the display to reflect the image zoom or pan operation; and
code that causes the processor to transmit, to the one or more other computing devices, a command for updating the displays of the one or more other computing devices to reflect the image zoom or pan operation.
